(19) United States
(12) Patent Application Publication
(10) Pub. No.: US 2016/0046519 A1
(43) Pub. Date: Feb. 18, 2016

(54) GLASS PLATE AND PROCESS FOR MANUFACTURING GLASS PLATE

(71) Applicant: NIPPON SHEET GLASS COMPANY, LIMITED, Tokyo (JP)

(72) Inventors: Satoshi TANAKA, Hyogo (JP); Kazuishi MITANI, Osaka (JP); Kiyomi FUKUSHIMA, Osaka (JP); Yasuhiro SAITO, Osaka (JP)

(73) Assignee: Nippon Sheet Glass Company, Tokyo (JP)

(21) Appl. No.: 14/783,004

(22) PCT Filed: Apr. 8, 2014
(86) PCT No.: PCT/JP2014/002011

§ 371 Date: Oct. 7, 2015

(30) Foreign Application Priority Data
Apr. 8, 2013 (JP) 2013-080650

(51) Int. Cl. C03B 18/14; C03C 17/245; C03B 18/20; C03C 15/00; C03C 21/00

(52) U.S. Cl. CPC C03B 18/14; C03C 15/00; C03C 21/002; C03B 18/20; C03C 17/245; C03C 2217/78

(57) ABSTRACT

The glass sheet of the present invention is a glass sheet with a thickness of 1.6 mm or less produced by a float process in which a molten glass material is formed into a sheet on a molten metal. When one surface of the glass sheet kept in contact with the molten metal during the formation of the molten glass material into the glass sheet is defined as a first surface and the other surface of the glass sheet opposite to the first surface is defined as a second surface, at least the first surface has a protective coating formed thereon by dealkalization, and the second surface has an etching rate of 2 nm/min or less when the second surface is etched using 0.1 mass % hydrofluoric acid at 50° C. as an etching liquid.

### TECHNICAL FIELD

The present invention relates to a glass sheet produced by a float process and having effectively reduced warping after chemical strengthening, and a method for producing the glass sheet.

### BACKGROUND ART

Image displays of mobile devices such as mobile phones, smart phones, and personal digital assistants (PDAs) have a touch panel mounted therein or a cover glass disposed thereon for surface protection. As such a touch panel or a cover glass, a chemically strengthened thin glass sheet with a thickness of 1.6 mm or less is commonly used. Chemical strengthening by alkali ion exchange is commonly used as an effective method for chemically strengthening thin glass sheets.

When a glass sheet produced by a float process is chemically strengthened, the glass sheet may be warped. It has been believed that this warping is caused by a tin layer that is formed in one surface (bottom surface) of the glass sheet kept in contact with molten tin in a float bath by entry of the tin component into the glass.

In other words, it has been believed that occurrence of warping of a glass sheet after chemically strengthening is caused by a difference in compressive stress between the bottom surface and the top surface (i.e., the other surface of the glass sheet kept out of contact with the molten tin during formation of the glass into the sheet). This difference in compressive stress is produced by the following mechanism: during chemical strengthening by alkali ion exchange, the presence of the tin layer formed in the bottom surface reduces the amount of K+ ions entering through the bottom surface, and as a result, makes it smaller than the amount of K+ ions entering through the top surface.

In a chemical strengthening method for float glass proposed in Patent Literature 1, the top surface of the glass kept out of contact with molten tin is subjected to chemical treatment for reducing the concentration of sodium ions in the top surface prior to chemical strengthening. It is believed that this chemical treatment restricts alkali ion exchange in the top surface during the chemical strengthening, leads to a decrease in the difference between the amount of alkali ions entering through the top surface and the amount of alkali ions entering through the bottom surface, and as a result, reduces warping of the glass sheet after the chemical strengthening. As used herein, the chemical treatment is a treatment in which an oxidizing gas such as chlorofluorocarbon gas, hydrogen fluoride (HF) gas, or sulfur dioxide (SO₂) gas is blown onto the surface of the glass sheet to allow the gas to react with the sodium component on the surface of the glass sheet.

On the other hand, in order to prevent damage to the surface of a glass sheet in the processes of producing, transporting, and processing the glass, it has been proposed to blow SO₂ gas onto the surface of the glass sheet in the production process to allow the SO₂ gas to react with an alkali component contained in the glass and thus to form a protective coating of sodium sulfate (salt cake) or the like on the glass surface (Patent Literature 2). Since the bottom surface is more susceptible to damage in the glass production process because it comes into contact with a conveyor roll, the protective coating needs to be sufficiently formed at least on the bottom surface.

### CITATION LIST

### Patent Literature

Patent Literature 1: JP 61(1986)-205641 A

Patent Literature 2: WO 2002/051767 A1

### SUMMARY OF INVENTION

### Technical Problem

With a growing demand for light weight mobile devices, glass sheets become thinner and thinner, and become more susceptible to warping by chemical strengthening. In addition, since the demand for highly damage-resistant, high quality glass sheets also increases, it becomes increasingly important to form a protective coating for preventing damage in the glass sheet production process. When a glass sheet having been subjected to surface treatment to form a damage-preventing protective coating as proposed in Patent Literature 2 is subjected to chemical strengthening, even if the glass sheet has been subjected to such a chemical treatment as proposed in Patent Literature 1 prior to the chemical strengthening, warping of the glass sheet is not sufficiently reduced in some cases. This tendency is clearly observed particularly in thin glass sheets with a thickness of 1.6 mm or less.

Accordingly, it is an object of the present invention to provide a glass sheet with reduced warping after chemical strengthening even if the glass sheet has been subjected to surface treatment for forming a damage-preventing protective coating thereon, and a method for producing the glass sheet.

### Solution to Problem

The surface treatment for glass by blowing SO₂ gas onto the glass surface to form a damage-preventing protective coating thereon is a treatment for removing an alkali component from the glass surface (dealkalization). As a result of intensive studies, the present inventors have found that not only the effect of the tin layer in the bottom surface but also the effect of this dealkalization needs to be considered to reduce warping after chemical strengthening. More specifically, the present inventors have found that a layer densified by dehydration condensation is formed on a dealkalized glass surface in some cases and this densified layer have an effect on alkali ion exchange during chemical strengthening in the same manner as does a tin layer, and as a result, have arrived at the following glass sheet of the present invention, taking the presence of the densified layer into consideration.

The present invention provides a glass sheet with a thickness of 1.6 mm or less produced by a float process in which a molten glass material is formed into a sheet on a molten metal. When one surface of the glass sheet kept in contact with the molten metal during the formation of the molten glass material into the glass sheet is defined as a first surface and the other surface of the glass sheet opposite to the first surface is defined as a second surface, at least the first surface has a protective coating formed thereon by dealkalization, and the second surface has an etching rate of 2 nm/min or less when the second surface is etched using 0.1 mass % hydrofluoric acid at 50° C. as an etching liquid.

The present invention further provides a method for producing a glass sheet with a thickness of 1.6 mm or less. The method includes the steps of:

(I) forming a molten glass material into a glass ribbon on a molten metal;

(II) when the glass ribbon is flowing on the molten metal, bringing a surface modification gas containing a fluorine element (F)-containing acid and water vapor into contact with a surface of the glass ribbon so as to form a densified dealkalized layer in the surface opposite to a surface of the glass ribbon kept in contact with the molten metal, the densified dealkalized layer having an etching rate of 2 nm/min or less when the layer is etched using 0.1 mass % hydrofluoric acid at 50° C. as an etching liquid; and

(III) forming a damage-preventing protective coating on at least the surface kept in contact with the molten metal.

### Advantageous Effects of Invention

The glass sheet of the present invention is a glass sheet produced by the float process. At least the first surface (bottom surface) of the glass sheet has been subjected to dealkalization to form a protective coating thereon, and the second surface (top surface) of the glass sheet has a very low etching rate, that is, a significantly densified dealkalized layer is provided in the top surface. In the glass sheet of the present invention, warping caused by chemical strengthening is reduced, even if a damage-preventing protective coating is sufficiently formed on the bottom surface of the glass sheet. In addition, since the top surface of the glass sheet of the present invention has a very low etching rate, the effect of the formation of an altered layer caused by the formation of a tin layer and a protective coating can be reduced, and thus operational flexibility can be ensured.

In the production method of the present invention, a surface modification gas containing a fluorine element (F)-containing acid and water vapor is brought into contact with a surface (top surface) of a glass ribbon flowing on molten metal so as to form a surface with a very low etching rate, that is, a top surface having a densified dealkalized layer therein. Therefore, like the glass sheet of the present invention, a glass sheet produced by the production method of the present invention is also a glass sheet with reduced warping caused by chemical strengthening, although a surface (bottom surface) of a glass ribbon kept in contact with molten metal has a protective coating formed thereon.

### DESCRIPTION OF EMBODIMENTS

Hereinafter, an embodiment of the present invention will be described in detail.

A glass sheet of the present embodiment is a glass sheet produced by a float process, which is a continuous glass sheet production method. In the float process, a glass material is melted in a melting furnace (float furnace) and the molten glass material is formed into a sheet-shaped glass ribbon on a molten metal in a float bath. The glass ribbon thus obtained is annealed in an annealing furnace and then cut into glass sheets of a predetermined size. In the present embodiment, the case where molten tin is used as the molten metal is described. Hereinafter, one surface of a glass sheet kept in contact with molten tin in a float bath in the forming step is referred to as a bottom surface (first surface), while the other surface of the glass sheet kept out of contact with the molten tin is referred to as a top surface (second surface) opposite to the bottom surface.

Furthermore, in the glass sheet of the present embodiment, at least the bottom surface thereof has been subjected to dealkalization for forming a damage-preventing protective coating thereon. As used herein, dealkalization refers to a treatment for bringing an alkali-reactive oxidizing gas into contact with the surface of the glass sheet so as to remove an alkali component from the glass. The removed alkali component reacts with the oxidizing gas, and as a result, a protective coating is formed on the surface of the glass sheet. As an oxidizing gas, for example, sulfur dioxide gas (SO₂ gas) can be used. SO₂ reacts with a component of the glass and forms alkali sulfate such as sodium sulfate on the surface of the glass sheet. This alkali sulfate serves as a protective coating. The oxidizing gas used herein may be a gas other than SO₂ gas as long as the gas can react with an alkali component in the glass to form a protective coating. This oxidizing gas may contain an inert gas such as air, nitrogen, or argon, as a carrier gas, and may further contain water vapor. A protective coating may also be formed on the top surface.

In the glass sheet of the present embodiment, the etching rate of the top surface is 2 nm/min or less when the top surface is etched using 0.1 mass % hydrofluoric acid at 50° C. as an etching liquid. This means that a significantly densified dealkalized layer is formed in the top surface. Thereby, a glass sheet with reduced warping after chemical strengthening can be obtained even if a protective coating is sufficiently formed on the bottom surface. Since the bottom surface has been in contact with molten tin in the float bath, a tin layer is formed in the bottom surface by entry of tin thereinto. The bottom surface further has a dealkalized layer to form a damage-preventing protective coating thereon. This dealkalized layer is relatively densified by dehydration condensation in some cases. An altered layer containing a reduced amount of alkali component is formed in the bottom surface by these tin layer and densified dealkalized layer, and this altered layer has an effect on alkali ion exchange during chemical strengthening. However, in the glass sheet of the present embodiment, the top surface is significantly densified (a significantly densified dealkalized layer is formed in the top surface). Therefore, the rate of alkali ion exchange in the top surface can be adjusted during chemical strengthening, thereby the effect of the altered layer formed in the bottom surface can be reduced. This densified layer in the top surface can be obtained by for example, bringing a surface modification gas containing a fluorine element-containing acid and water vapor into contact with the surface of the glass. The etching rate can be controlled by adjusting the concentration of the acid contained in the surface modification gas, the ratio of the acid and water vapor in the gas, the temperature and time of contact between the surface modification gas and the glass surface, etc.

The dealkalized layer in the top surface is a densified layer as described above. The dealkalized layer in the bottom surface changes to a densified layer in some cases, as described above. These densified layers can be formed by densification subsequent to dealkalization. Instead of the alkali component removed from the glass by dealkalization, atmospheric water in various forms, such as in the form of proton (H+) and oxonium ion (H₃O+), enters the glass and forms a silanol group (≡Si—OH) in the dealkalized layer. Then, a siloxane bond (≡Si—O—Si≡) is formed by dehydration condensation of the silanol group. In this description, “densification” is defined as the state in which siloxane bonds are increased by this dehydration condensation. Since the glass surface having increased siloxane bonds is more resistant to etching, the degree of densification can be obtained by measuring the etching rate.

It is desirable that the etching rate of the top surface be 1 nm/min or less. Thereby, the amount of warping after chemical strengthening can further be reduced. It is desirable that the etching rate of the top surface be 0.5 nm/min or more because when the etching rate is too low, it takes a longer time to obtain desired strength in chemical strengthening, which may cause a decrease in productivity.

Soda lime glass or aluminosilicate glass, which is commonly available for use as glass for chemical strengthening, can be used for the glass sheet, and the composition of the glass is not particularly limited. A thin glass sheet with a thickness of 1.6 mm or less is particularly susceptible to warping after chemical strengthening. Therefore, the thickness of the glass sheet of the present embodiment is 1.6 mm or less. In particular, when the present invention is applied to a thin glass sheet with a thickness of 1.1 mm or less, remarkable effects can be obtained.

The glass sheet of the present embodiment can be produced, for example, by a method including the steps of: (I) forming a molten glass material into a glass ribbon on molten tin (molten metal); (II) when the glass ribbon is flowing on the molten metal, bringing a surface modification gas containing a fluorine element (F)-containing acid and water vapor into contact with a surface of the glass ribbon; and (III) forming a damage-preventing protective coating on at least a surface of the glass ribbon kept in contact with the molten metal.

First, a glass material melted in a float furnace (molten glass) flows from the float furnace and is fed into a float bath. The molten glass thus fed into the float bath is formed into a sheet-like glass ribbon while spreading over molten tin in the float bath. As the glass ribbon flows along the float bath, the thickness of the glass ribbon is adjusted to 1.6 mm or less. In the float bath, a surface modification gas containing a fluorine element (F)-containing acid and water vapor is brought into contact with a surface of the high-temperature glass ribbon flowing on the molten tin so as to form a significantly densified dealkalized layer in the surface of the glass ribbon.

Since the temperature of the glass ribbon on the molten tin is much higher than the glass transition temperature, modification of the glass surface is effectively achieved. In order to significantly densify the glass surface, it is important that the surface modification gas contain water vapor in addition to a fluorine element-containing acid. When this surface modification gas is brought into contact with the surface of the high-temperature glass ribbon, alkali ions in the glass surface are eluted, and the components of the surface modification gas, in various forms such as in the form of protons (H+) and oxonium ions (H₃O+), enter the glass. Then, the water entering the glass is removed by dehydration condensation, during which the glass surface is densified.

The fluorine element-containing acid contained in the surface modification gas is more corrosive to glass than other acids. Any acids such as hydrogen fluoride (HF), hydrofluosilicic acid (H₂SiF₆), and chlorofluorocarbons such as CCl₃F and CCl₂F₂ can be used, but in particular, hydrogen fluoride is preferred. Since hydrogen fluoride breaks Si—O bonds that are basic structures of the glass, it is easy for the components of the surface modification gas such as water and oxonium ions to enter the glass. Through phenomena such as corrosion of glass by hydrogen fluoride and reprecipitation of glass occurring in a complicated manner, the water having entered the glass leaves the glass through dehydration condensation reaction. Thus, the glass surface is significantly densified.

In the surface modification gas, the concentration of the water vapor is desirably higher than the concentration of the fluorine element-containing acid, and the volume ratio of the water vapor to the acid (the volume of the water vapor/the volume of the acid) is desirably 8 or more. In the surface modification gas, the concentration of the water vapor is desirably 8 to 80 vol. %, and the concentration of the fluorine element-containing acid is desirably 1 to 10 vol. %. With the use of the surface modification gas containing the acid and the water vapor in these ranges, a more significantly densified dealkalized layer can be formed. It should be noted that the surface modification gas may contain an inert gas such as nitrogen gas or argon gas in addition to the fluorine element-containing acid and the water vapor.

The temperature of glass in a float bath is very high. In the case of common soda lime glass, its temperature is about 600 to 1050° C., depending on its composition. The surface modification treatment in such a high-temperature float bath is very advantageous in terms of energy efficiency and makes it possible to form a significantly densified dealkalized layer in a short time. It is desirable that the temperature of the glass be 600 to 740° C. when the surface modification gas is brought into contact with the glass. When the temperature of the glass is in this range, a significantly densified dealkalized layer can be formed efficiently

As described above, since the efficiency of the reaction between the glass and the surface modification gas is very high when the gas is brought into contact with the glass surface in the float bath, a sufficiently densified dealkalized layer can be obtained with a glass contact time of only about 1 to 10 seconds.

Since the surface modification gas contains water vapor, it is desirable to collect and remove the surface modification gas from the float bath immediately after the necessary treatment is completed to prevent leakage of the gas in the float bath. Therefore, when the surface modification gas is brought into contact with the glass in the float bath, it is desirable to use a gas supply device provided with a mechanism for collecting and removing the gas after the surface modification treatment. For example, a device as described in JP 2001-503005 T can be used. An embodiment in which such a device is used is described below.

In the float bath, a surface modification gas supply device is disposed at a predetermined distance from the surface of a glass ribbon on molten tin. A plurality of gas supply devices may be disposed. The temperature of the glass ribbon is adjusted by a heating means or a cooling means provided in the float bath so that the glass ribbon has a predetermined temperature in the vicinity of the gas supply device. The surface modification gas is supplied from a gas blowing means provided in the gas supply device to the surface of the glass ribbon flowing on the molten tin. The acid concentration and the water vapor concentration in the surface modification gas can be adjusted by adjusting the flow rate of the acid and that of the water vapor. Upon reaching the surface of the glass ribbon, the surface modification gas flows over the surface of the glass ribbon while causing dealkalization reaction and densification reaction by dehydration condensation, and is collected by a gas collecting means provided in the gas supply device and discharged out of the float bath.

The glass ribbon having the surface-modified top surface is cooled in the float bath to have a viscosity enough to be pulled off the float bath. The cooled glass ribbon is lifted off the float bath by a roller provided downstream of the float bath and delivered to an annealing furnace. The annealing furnace is provided with gas blowing nozzles for dealkalization treatment. The nozzles are provided in such a manner that they can blow the oxidizing gas onto only the bottom surface of the glass ribbon or both the bottom surface and the top surface thereof. The amount of the gas blown from the nozzles can be controlled by a controller. The annealing furnace is further provided with a heating means and a cooling means, and thereby the dealkalization temperature can be set within a predetermined range. It is possible to control the degree of dealkalization and thus to change the amount of deposited protective coating by setting as appropriate the amount of the blown oxidizing gas and the treatment temperature. The glass ribbon having a protective coating formed at least on its bottom surface in this manner is further cooled while flowing in the annealing furnace, and then cut into glass sheets of a predetermined size by a cutter.

In order to chemically strengthen the glass sheet of the present embodiment, it is desirable to further carry out, after the step (III), a step of (IV) subjecting a glass sheet obtained by cutting the glass ribbon to chemical strengthening by alkali ion exchange. The amount of warping of the chemically strengthened glass sheet obtained by this step is reduced to a lower level, and thus this glass sheet has both high flatness and high strength.

### EXAMPLES

Hereinafter, the present invention is described in more detail by way of examples. However, the present invention is not limited to the following examples, without departing from the scope of the present invention.

### Examples 1 and 2

[Method for producing glass sheet]

Glass sheets with a thickness of 1.1 mm were produced by a float process. First, a glass material was prepared so as to have the following composition of glass: 70.8% of SiO₂, 1.0% of Al₂O₃, 8.5% of CaO, 5.9% of MgO, 13.2% of Na₂O, and 0.6% of K₂O, where “%” means “mass%”. This glass material was melted, and the molten glass material was formed into a 1.1 mm thick sheet-shaped glass ribbon on molten tin in a float bath. In addition, using a gas supply device provided in the float bath, a surface modification gas containing hydrogen fluoride and water vapor was supplied together with nitrogen as a carrier gas to a surface of the glass ribbon having a temperature of 660° C., whereby a dealkalized layer densified by dehydration condensation was formed in the top surface of the glass ribbon. The time of contact of the surface modification gas with the glass surface was 2.4 seconds. The acid concentration (concentration of hydrogen fluoride), the concentration of the water vapor, and the volume ratio of the water vapor to the acid in the surface modification gas are as shown in Table 1. Thereafter, dealkalization was performed by blowing SO₂ gas onto the bottom surface of the glass sheet in the annealing furnace, and thus a protective coating was formed thereon.

[Method for measuring etching rate]

The etching rate of the obtained glass sheet was evaluated based on the etching rate calculated from the time for which the glass sheet was immersed in 0.1 mass % hydrofluoric acid at 50° C. as an etching liquid to obtain a given etching amount. The etching amount was measured by applying a hydrofluoric acid-resistant masking agent onto a portion of the unetched glass sheet, subjecting the glass sheet to etching, and measuring the difference in the level between the masked portion and the etched portion formed by etching. The level difference was measured using a thickness meter (Alpha-Step 500 manufactured by KLA-Tencor Corporation). The time required for the level difference of 20 nm was obtained, and this 20 nm was divided by the time obtained so as to calculate the etching rate. Table 1 shows the measurement results of the etching rates. Here, the level difference of 20 nm was set so that only the etching rate of the altered layer formed in the surface of the glass sheet could be measured independently of the etching rate of the bulk layer inside the glass sheet. Specifically, a plurality of data of the level difference (etching depth) with respect to the etching time were collected, and the etching depth was plotted on the vertical axis while the etching time was plotted on the horizontal axis. When the plots were connected, a straight line having a gentle slope was observed between the plots in a short time region, while a straight line having a steeper slope was observed between the plots in a longer time region. Thus, a bending point was observed between the lines. It was presumed that the etching depth at which this bending point was observed was the depth at which the composition of the altered layer changed to that of the bulk layer. Therefore, the etching depth (20 nm in this case) was selected so that the etching depth did not reach the bulk layer.

[Method for chemical strengthening]

A sample having a size of 370 mm×470 mm was cut out from each glass sheet and subjected to chemical strengthening. First, the sample was washed, and then immersed in a molten salt of KNO₃. The temperature of the molten salt of KNO₃ was set to 460° C., and the immersion time was set to 2.5 hours. The sample was taken out from the molten salt of KNO₃ and then cooled, followed by washing to remove KNO₃ attached to the sample.

[Method for measuring amount of warping]

The amount of warping of the glass sheet was measured both before and after the chemical strengthening. The sample glass sheet was placed on a flat surface plate in such a manner that the top surface faced downward and the bottom surface faced upward, and the distance between the sample and the surface plate were measured using a gap gauge at eight points, i.e., at the four corners of the sample and the centers of the four sides of the sample. The maximum value of the distance was used as the amount of warping in the sample. The values of the maximum amount of warping were measured for 18 samples, and the average value thereof was determined. Table 1 shows the results.

### Comparative Examples 1 and 2

Glass sheets were produced in the same manner as in Examples 1 and 2 except that the treatment was performed with the hydrogen fluoride concentrations and the water vapor concentrations as shown in Table 1. It should be noted that Comparative Example 2 was a conventional float glass whose top surface had not been modified in a float bath. For each of the obtained glass sheets, the etching rate was measured, chemical strengthening was performed, and the amount of warping was measured in the same manner as in Examples 1 and 2. Table 1 shows the results.

TABLE 1

| | Exam- | Exam- | Com. Exam- | Com. Exam- |
|---|---|---|---|---|
| | ple 1 | ple 2 | ple 1 | ple 2 |
| Etching rate of top | 0.9 | 1.5 | 6.5 | 10.7 |
| surface (nm/min) | | | | |
| Amount of warping | 0.25 | 0.43 | 0.51 | 0.50 |
| after chemical | | | | |
| strengthening (mm) | | | | |
| Amount of warping | 0.10 | 0.10 | 0.10 | 0.10 |
| before chemical | | | | |
| strengthening (mm) | | | | |
| Hydrogen fluoride | 2.5 | 1.0 | 0.2 | — |
| concentration (vol. %) | | | | |
| Water vapor | 50.0 | 20.0 | 2.0 | — |
| concentration (vol. %) | | | | |
| Volume of water | 20 | 20 | 20 | — |
| vapor/Volume of acid | | | | |

The etching rates of the top surfaces of the glass sheets of Examples 1 and 2 were 2 nm/min or less, which reveals that the top surfaces were significantly densified, and the amounts of warping after chemical strengthening were reduced by at least about 15% as compared to the amount of warping in Comparative Example 2. In Example 1, the etching rate of the top surface was 1 nm/min or less and the amount of warping was further reduced. In contrast, in Comparative Example 1, the etching rate was 6.5 nm/min and the amount of warping after chemical strengthening showed little improvement.

The results of the above Examples and Comparative Examples confirmed that a glass sheet whose top surface has an etching rate of 2 nm/min or less has reduced warping after chemical strengthening.

### INDUSTRIAL APPLICABILITY

In the glass sheet of the present invention, warping after chemical strengthening can be reduced. Therefore, the glass sheet of the present invention is suitably used for applications that require thinness and strength, for example, for a cover glass for protecting the surface of an image display of a mobile device. In addition, the surface of the glass sheet of the present invention is significantly densified and thus the elution of an alkali component in the glass can be prevented.

Therefore, this glass sheet can be expected to prevent weathering of glass and degradation of the performance of a functional thin film coating formed on the glass. Consequently, the glass sheet of the present invention can also be used for applications such as glass sheets for building windows and vehicle windows, and glass substrates for photoelectric conversion devices including solar cells.

1. A glass sheet with a thickness of 1.6 mm or less produced by a float process in which a molten glass material is formed into a sheet on a molten metal, wherein
when one surface of the glass sheet kept in contact with the molten metal during the formation of the molten glass material into the glass sheet is defined as a first surface and the other surface of the glass sheet opposite to the first surface is defined as a second surface, at least the first surface has a protective coating formed thereon by dealkalization, and
the second surface has an etching rate of 2 nm/min or less when the second surface is etched using 0.1 mass % hydrofluoric acid at 50° C. as an etching liquid.

2. A method for producing a glass sheet with a thickness of 1.6 mm or less, comprising the steps of:
(I) forming a molten glass material into a glass ribbon on a molten metal;
(II) when the glass ribbon is flowing on the molten metal, bringing a surface modification gas containing a fluorine element (F)-containing acid and water vapor into contact with a surface of the glass ribbon so as to form a densified dealkalized layer in the surface opposite to a surface of the glass ribbon kept in contact with the molten metal, the densified dealkalized layer having an etching rate of 2 nm/min or less when the layer is etched using 0.1 mass % hydrofluoric acid at 50° C. as an etching liquid; and
(III) forming a damage-preventing protective coating on at least the surface kept in contact with the molten metal.

3. The method for producing a glass sheet according to claim 2, wherein the fluorine element (F)-containing acid is hydrogen fluoride (HF).

4. The method for producing a glass sheet according to claim 2, further comprising, after the step (III), a step of (IV) subjecting a glass sheet obtained by cutting the glass ribbon to chemical strengthening by alkali ion exchange.

5. The method for producing a glass sheet according to claim 3, further comprising, after the step (III), a step of (IV) subjecting a glass sheet obtained by cutting the glass ribbon to chemical strengthening by alkali ion exchange.
